(19) United States
(12) Patent Application Publication
(10) Pub. No.: US 2021/0237908 A1
(43) Pub. Date: Aug. 5, 2021

(54) Apparatus and Method for Packaging and Deploying Large Structures using Hexagons

(71) Applicant: Cory Lawrence JOHNS, Drain, OR (US)

(72) Inventor: Cory Lawrence JOHNS, Drain, OR (US)

(21) Appl. No.: 17/234,253

(22) Filed: Apr. 19, 2021

Related U.S. Application Data
(63) Continuation of application No. 15/872,689, filed on Jan. 16, 2018.
(60) Provisional application No. 62/499,181, filed on Jan. 18, 2017.

(51) Int. Cl. B64G 1/00

(52) U.S. Cl. CPC B64G 1/002; E05D 11/00; E05Y 2900/60

(57) ABSTRACT

An apparatus and a method for packaging a large size flat structure into a hexagonal column, allowing higher packaging density without sacrificing the two-dimensional size of the flat structure, and for deploying and unstacking the hexagonal column.

### CONTINUITY AND CLAIM OF PRIORITY

This application is a continuation under 35 U.S.C. § 120 of U.S. application Ser. No. 15/872,689 filed 16 Jan. 2018 and claims the benefit under 35 U.S.C. § 119(e) of U.S. Provisional Application Ser. No. 62/499,181 filed 18 Jan. 2017.

### FIELD

This invention is in the technical field of packaging and deploying structures, and is particularly useful in packaging, launching and deploying large and giant structures to and in space and/or for collecting solar energy.

### BACKGROUND

Hexagons have been used in the construction of space structures, such as James Webb Space Telescope, because hexagons are not only the best approximation of circles but also have a high filling factor which means can also uniformly tile into a substantially flat structure with zero or minimal gap. However, the large or giant size of space structures poses a challenge in launching them into space, because of the limited size and shape of a launching vehicle, which is usually and generally in the shape of a cylinder.

Currently, to launch and deploy a large flat structure containing hexagon panels, the structure is folded into several groups of flat pieces of hexagons and once in space, these pieces are tiled back into one flat configuration. For example, the James Webb Space Telescope has a combined golden mirror with a diameter of 6.5 m containing 18 hexagonal-shaped mirror segments. To package the James Webb Space Telescope for launching, the mirror with a 6.5-meter-diameter is folded into three flat pieces like leaves of a drop-leaf table so that the mirror and the Telescope can fit into a launching rocket. Once launched in space, the pieces are unfolded and tiled back as the one-piece mirror, flat to flat. Information about the large golden mirror of the James Webb Space Telescope is available at https://jwst.nasa.gov/mirrors.html.

While a big or large flat structure can be packaged, launched and deployed by using hexagonal-shaped segments and by using the methods as in the James Webb Space Telescope, an apparatus and/or a method that allows the packaging, launching and deploying of much larger structures with diameters greater than the James Webb Telescope is desirable for commercial and scientific needs.

### SUMMARY

This invention addresses the packaging and deployment of a two-dimensional, flat structure containing hexagon panels. By connecting the hexagon panels in a particular sequence, this invention creates an apparatus and a method that allow the hexagon panels to be packaged or stacked into a hexagonal column which occupies significantly less space without losing any desired two-dimensional size of the structure once deployed. The apparatus is restored to be a flat structure by reversing the sequence when unfolding or unstacking the hexagons and then securing the hexagons with adjacent hexagons. This invention also allows much larger structures to be packaged, launched and deployed in space with current launching vehicles.

### BRIEF DESCRIPTION OF DRAWINGS

FIG. 1 is a two dimensional demonstration of an embodiment of the invented apparatus when it is in the form of a flat structure.

FIG. 2 shows the deployment process of an embodiment of the invented apparatus, from a hexagonal column to a flat configuration.

FIG. 3 shows an embodiment of the invention in the form of a hexagonal column expanded slightly.

FIG. 4 is an embodiment of the invention where the flat configuration of the apparatus is tiled to be a ring of hexagons having one complete layer of hexagons.

FIGS. 5A-5B illustrate two modes of an embodiment of the invention which includes an expandable member for adjusting the thickness of the hexagons. FIG. 5A shows an expanded mode of a hexagon. FIG. 5B shows the compressed mode of a hexagon.

### DETAILED DESCRIPTION

Embodiments of the invention is an apparatus and a method that use a unique sequence to connect hexagons for tiling the hexagons into a large flat configuration and by tracing the reverse direction of the connecting sequence, stacking the hexagons into a hexagonal column by folding the hexagons with alternating folding directions. The hexagonal column can be unstacked or unfolded to return the apparatus back to the form of a large flat configuration. When the apparatus is in the form of a flat configuration, the adjacent hexagons are secured with each other for the stability of the flat configuration.

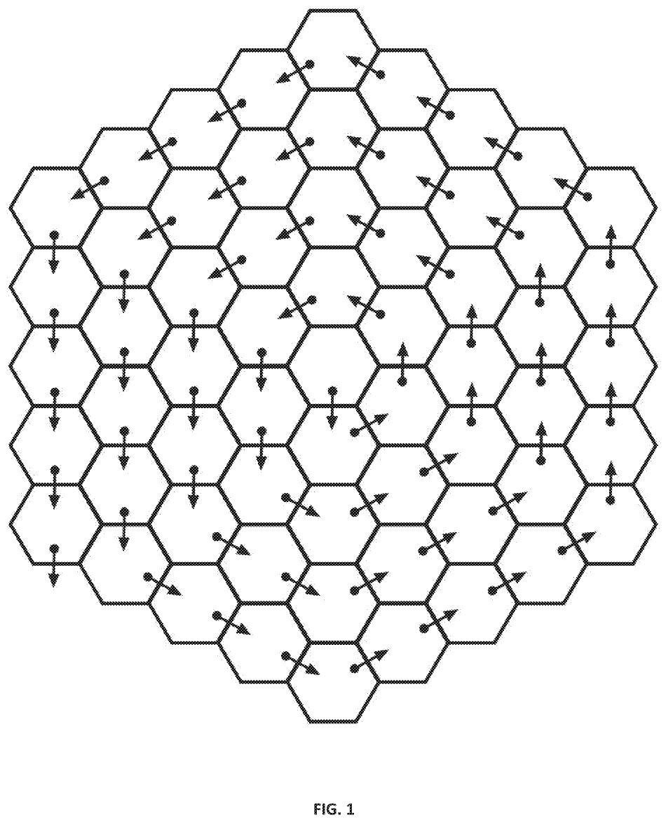

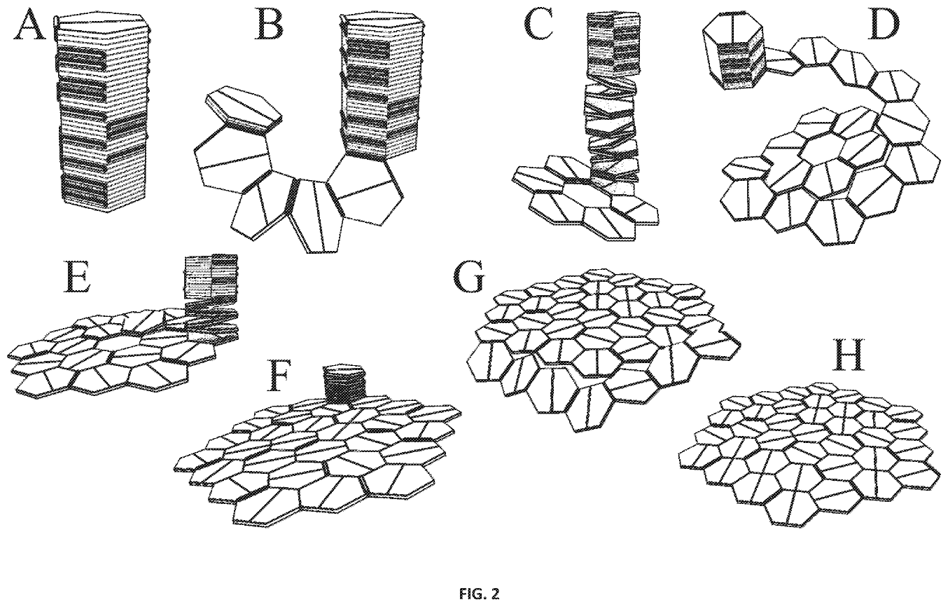

The arrows in FIG. 1 represent one direction of the connecting sequence for tiling the hexagon panels during initial construction. The direction of the connecting sequence shown in FIG. 1 may be reversed. Each arrow in FIG. 1 crosses a hinge or a connector that permanently connects the two adjacent hexagons. By following the generally circular direction of the connecting sequence, the hexagons can be tiled into a very large flat configuration with an unlimited number of hexagons. To construct the apparatus, each of the hexagons is permanently connected by following the connecting sequence, leaving no or minimal gap among adjacent hexagons and no overlapping hexagons. While it is easier to follow the order of the connecting sequence, it is also possible to connect the hexagons in any order so long as the hexagons are connected using the connecting sequence. To prepare for packaging and launching, the hexagons are stacked in alternating folding directions and by reversely tracing the connecting sequence (reversal of the arrow direction in FIG. 1), resulting in a hexagonal column as shown in FIG. 2A. The hexagonal column fits well inside a launching vehicle that is usually a cylinder.

Once launched into space and outside the launching vehicle, the apparatus in its hexagonal column shape (shown in FIG. 2A) is ready to be deployed. As shown in FIGS. 2B-2G, the hexagons are gradually deployed while being tiled to form a two-dimensional surface by tracing the connecting sequence as in FIG. 1. Once all the hexagons are deployed and tiled, the apparatus takes the form of the flat configuration (shown in FIG. 2H). The hexagons are then secured with adjacent hexagonal segments using securing members. Securing members are mounted on all sides of the hexagons that are not on the trace of the connecting sequence, which are the sides not crossed by arrows as shown in FIG. 1.

When deploying the hexagons, the hexagons may be deployed one by one. A more efficient way to deploy the hexagons is to deploy a number of hexagons simultaneously in a controlled manner to allow unfolding without colliding any hexagons. An example of simultaneously deploying a group of hexagons is shown in FIG. 3.

The hinges for connecting the hexagons may fold both directions or only one direction. In the embodiment where the hinges fold only one direction, the hinges must be mounted in an alternating top and bottom manner on the hexagons that follow the trace of the connecting sequence to allow the alternating folding directions of the hexagons. In the embodiment where the hinges fold both directions, the mounting direction of the hinges is irrelevant, but the stacking direction of the hexagons must follow alternating folding directions.

In one embodiment of the invention, the securing members and the hinges are one and the same, both of which are connectors serving the function of connecting the hexagons permanently when constructing the apparatus and securing the hexagons permanently once the apparatus is fully deployed and tiled.

The hinges, securing members, or connectors are powered in order to fold and unfold the hexagons as needed. The power may be electric, elastic (for example, using springs), magnetic, created by using a shape-memory material, or by chemical reactions.

The preferred construction and use of the invented apparatus contain hexagons without limitation of number, because the purpose of the invention is to allow a giant flat structure to be collapsed into a compact hexagonal column that takes a minimal space (cylindrical or elongated shape) for launching. However, because the minimum number required to form a ring of hexagons is six, six is the preferred minimum number of hexagons to be used for purpose of this invention.

The applications of the invented apparatus and method can be in connection with mirrors and solar cell arrays in or with the hexagon tiles. The two exterior surfaces of each of the hexagons (not interior surfaces between layers inside a hexagon if a hexagon comprises layers) should be clear from obstruction to allow consistent and unobstructed stacking.

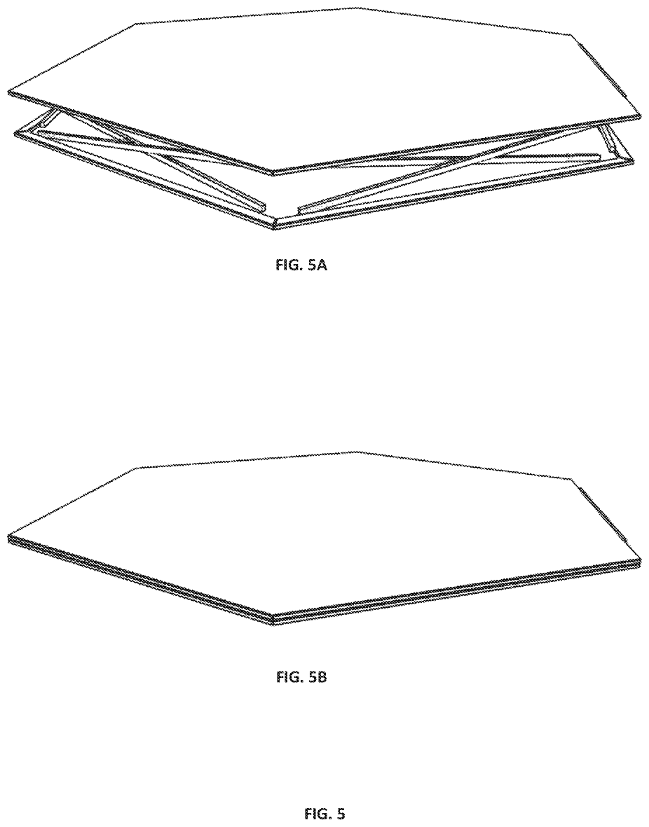

The height of a hexagonal column can be reduced by using hexagon tiles made of a material with the flexibility to be compressed and then restored when needed. Another embodiment of the invention uses an expandable member inside each hexagon tile for adjusting the thickness of the hexagon tiles. In this embodiment, the hexagon tiles comprises at least two layers and the expandable member is installed between the layers. The expandable member may use crossed bars along the hexagon sides as shown in FIG. 5A. The expandable member may use other mechanisms such as inflatable spacers, springs, and/or using a UV rigidizer. With the expandable member, the hexagonal column may be made shorter when packaging and launching, hence allowing the apparatus to connect even more hexagons to result into an even larger flat configuration.

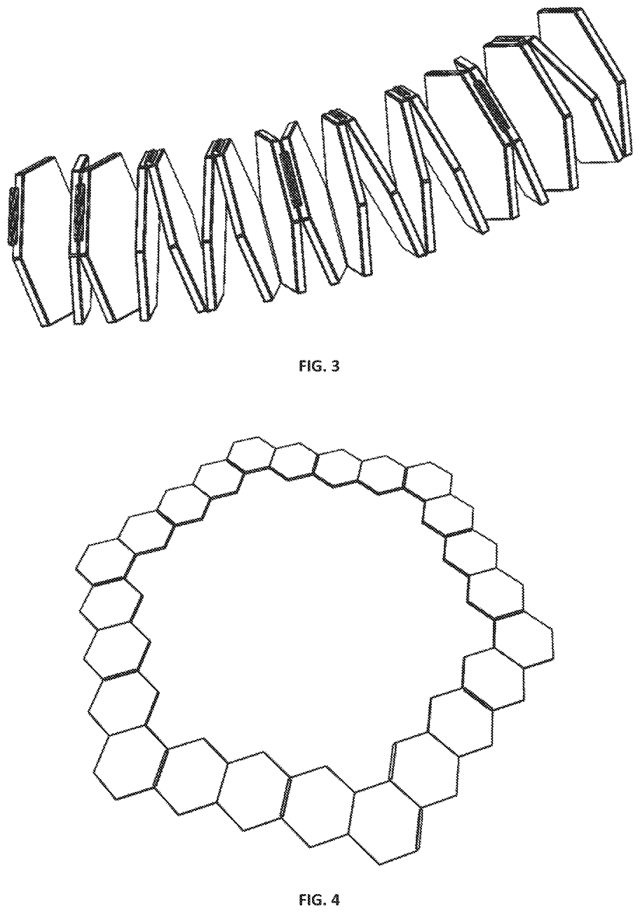

While it may be most useful to fully tile the flat configuration of the apparatus in one embodiment, for example, maximizing the area for collecting solar energy, it may be desirable to not fully tile the flat configuration in another embodiment, for example, a ring of hexagons having only one complete circled layer of hexagons as shown in FIG. 4, or a flat configuration missing a center hexagon.

It is noted that, as used in this specification and the appended claims, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or other items that can be added to the listed items.

Upon studying the disclosure, it will be apparent to those skilled in the art that various modifications and variations can be made in the invention and methods of various embodiments of the invention. Other embodiments will be apparent to those skilled in the art from consideration of the specification and practice of the embodiments disclosed herein. It is intended that the specification be considered as examples only. The various embodiments are not necessarily mutually exclusive, as some embodiments can be combined with one or more other embodiments to form new embodiments.

I claim:

1. An apparatus comprising:
a plurality of interconnected, similar-sized regular hexagonal tiles having a folded configuration and an unfolded configuration, each tile of the plurality of interconnected, similar-sized regular hexagonal tiles having a uniform side length, a thickness, a front surface and a back surface,
said folded configuration to fit within a cylinder having a radius no less than the uniform side length and a length no less than a sum of the thicknesses of all of the interconnected, similar-sized regular hexagonal tiles, and
said unfolded configuration being a substantially planar area covered by the interconnected, similar-sized regular hexagonal tiles without overlap, wherein
the plurality of interconnected, similar-sized regular hexagonal tiles comprises a first tile, a last tile, and at least four (4) intermediate tiles;
the first tile is connected to a first of the at least four intermediate tiles by a foldable connector and to no other tiles;
the last tile is connected to a last of the at least four intermediate tiles by a foldable connecter and to no other tiles;
each intermediate tile is connected to exactly two other neighboring tiles of the plurality of interconnected, similar-sized regular hexagonal tiles by exactly two foldable connectors, and wherein
in the folded configuration, a front surface of each intermediate tile faces a front surface of a first neighboring tile of the two neighboring tiles; and a back surface of the each intermediate tile faces a back surface of a second, different neighboring tile of the two neighboring tiles.

2. The apparatus of claim 1 wherein the substantially planar area is a hexagonal shape.

3. The apparatus of claim 1 wherein the substantially planar area is a ring shape.

4. The apparatus of claim 1 wherein one of the regular hexagonal tiles is an expandable hexagonal tile, the expandable hexagonal tile comprising an expandable member and having a compressed state and an expanded state, wherein
when the expandable hexagonal tile is part of the folded configuration, the expandable hexagonal tile is in the compressed state and has the thickness, and
when the expandable hexagonal tile is part of the unfolded configuration, the expandable hexagonal tile is in the expanded state and has a second, greater thickness.

5. A packed configuration for launching a planar array of n hexagonal panels, comprising:
n flat hexagonal panels, each panel having six (6) edges, a front face and a rear face, said hexagonal panels numbered from 1 to n; and
n−1 foldable connectors, each connector coupled between a first edge of an i^{th} hexagonal panel and a second edge of a j^{th} hexagonal panel, wherein
each flat hexagonal panel has at least one (1) but no more than two (2) foldable connectors coupled to different edges of the six (6) edges of the each flat hexagonal panel,
a front face of the i^{th} hexagonal panel is adjacent a front face of the j^{th} hexagonal panel and a rear face of the j^{th} hexagonal panel is adjacent a rear face of a k^{th} hexagonal panel, and wherein
n is an integer exceeding five (5) and i, j, and k are successive integers not exceeding n.

6. The packed configuration of claim 5 wherein n is six (6).

7. The packed configuration of claim 5 wherein n is twenty-four (24).

8. The packed configuration of claim 5 wherein n is sixty-one (61).

9. The packed configuration of claim 5 wherein the n−1 foldable connectors are numbered from 1 to n−1,
each foldable connector has a folded state and an unfolded state,
each foldable connector is in the folded state when the flat hexagonal panels are in the packed configuration, and
when the n−1 foldable connectors are changed, one by one, from the folded state to the unfolded state, no hexagonal panel of the n hexagonal panels collides with any other hexagonal panel of the n hexagonal panels.

10. The packed configuration of claim 9 wherein:
after the n−1 foldable connectors are changed from the folded state to the unfolded state, the n flat hexagonal panels cover a substantially planar area, and
the n−1 foldable connectors follow a generally circular connecting sequence from 1 to n−1.

11. The packed configuration of claim 9 wherein:
after the n−1 foldable connectors are changed from the folded state to the unfolded state, the n flat hexagonal panels cover a substantially planar area, and
the n−1 foldable connectors follow a generally spiral connecting sequence from 1 to n−1.

12. A method for packing a plurality of similar interconnected hexagonal tiles arranged to cover a planar area without overlap into a cylindrical space having a radius no less than a length of one hexagonal tile side and a length no less than a sum of a thickness of all of the identical interconnected hexagonal tiles, wherein the plurality of identical interconnected hexagonal tiles consists of a first tile, a last tile, and at least one intermediate tile connected in a single sequence without branching,
said first tile connected to a first intermediate tile by a first foldable connector along a first edge between the first tile and the first intermediate tile,
said last tile connected to a last intermediate tile by a last foldable connector along a last edge between the last tile and the last intermediate tile, and
each of the at least one intermediate tile is connected to exactly two other neighboring tiles by intermediate foldable connectors along two intermediate edges between each of the at least one intermediate tile and the exactly two other neighboring tiles, said method comprising:
folding the first foldable connector so that a face of the first tile is adjacent to a face of the first intermediate tile;
folding each subsequent intermediate foldable connector so that a face of one intermediate tile is brought adjacent a face of a neighboring intermediate tile, each folding operation in an opposite direction to a previous folding operation; and finally
folding the last foldable connector so that a face of the last tile is adjacent to a face of the last intermediate tile.

13. The method of claim 10 wherein a result of the folding operations is a stack of hexagonal tiles, the method further comprising:
placing the stack of hexagonal tiles into a cylindrical launching vehicle;
launching the cylindrical launching vehicle into orbit;
removing the stack of hexagonal tiles from the cylindrical launching vehicle after reaching orbit; and
unfolding the first foldable connector, the last foldable connector, and each of the intermediate foldable connectors so that the interconnected hexagonal tiles cover the planar area without overlap.

14. The method of claim 11, further comprising:
securing pairs of adjacent hexagonal tiles of the interconnected hexagonal tiles covering the planar area without overlap to each other.
